(19) United States
(12) Patent Application Publication
(10) Pub. No.: US 2014/0160423 A1
(43) Pub. Date: Jun. 12, 2014

(54) INTEGRALLY MOLDED APPARATUS FOR HEADWEAR AND WRAP EYEWEAR

(71) Applicant: Kelly Coty, Nashville, TN (US)

(72) Inventor: Kelly Coty, Nashville, TN (US)

(21) Appl. No.: 13/709,570

(22) Filed: Dec. 10, 2012

(51) Int. Cl. G02C 7/02; G02C 5/14

(52) U.S. Cl. CPC G02C 7/022; G02C 5/14
USPC 351/111

(57) ABSTRACT

A combined headwear and eyewear apparatus is integrally constructed of a transparent and thermoplastic material with first and second opposing temples and a front to define a substantially continuous arcuate interior shaped to fit the head of a user. The temples and non-magnifying portions of the front include or define a number of curved sub-portions shaped with a first base curve of for example 6.0 Diopters. The front further integrally includes magnification portions each shaped according to a desired magnification level and having a larger base curve of for example at least 6.5 Diopters. In preferred embodiments, the thermoplastic material may be a clear or tinted polycarbonate resin.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: None

### BACKGROUND OF THE INVENTION

The present invention relates generally to prescription eyewear that can also serve as a headband. More particularly, the present invention relates to an integrally molded apparatus of a particular wrap configuration such that in a first position on a user's head it functions as a hairband and in a second position on the user's head it functions as prescription eyewear.

Hairbands are generally characterized by a one-piece cylindrical or spherical configuration. Therefore, a combination of a hairband with eyewear is not conventionally known as such a configuration is incompatible with acceptable presbyopic eyewear such as eyeglasses. Two optical lenses could technically be aligned on one cylindrical object, but it would likely fail CE or ANSI optical standards, and would almost certainly cause viewing discomfort for the user. Such a sharp optical arc in the viewing area would almost inherently cause tremendous difficulties in obtaining the right degree of focus on objects of varying distance.

Therefore, the optical lenses must be somewhat flattened with respect to a purely cylindrical configuration. It is known in the prior art to provide physical attachment means whereby lenses can be manually added to for example a lower position of a hairband, but such a configuration has obvious aesthetic failings.

Wrap eyewear is well-known in the art for providing an angled viewing area, but such eyewear is conventionally only available in the form of frames that are custom fitted with separate lenses, rather than being integrally molded such as a conventional hairband.

It is further known to provide an integrally molded apparatus with a flattened front for the purpose of providing magnification, such as for example has been provided in the context of safety glasses.

It would be desirable to provide a hairband of a one-piece, continuous arc configuration which could be slid into a viewing position and would fit the shape of a user's face rather than have a flattened front.

It would be further desirable that such a hairband/eyewear combination further support two optical portions with magnification lenses.

It would be even further desirable that such a hairband/eyewear combination include lens extensions with respect to the viewing area so as to provide or support a streamlined and aesthetically pleasing shape, without compromising the magnification requirements and otherwise adhering to optical standards.

### BRIEF DESCRIPTION OF THE SEVERAL VIEWS OF THE DRAWINGS

FIG. 1 is an overhead isometric view of an embodiment of an apparatus according to the present invention.

FIG. 2 is an overhead view of the apparatus according to the present invention with respect to FIG. 1.

FIG. 3 is an inverted isometric view of the apparatus according to the present invention with respect to FIG. 1.

FIG. 4 is a front view of the apparatus according to the present invention with respect to FIG. 1.

FIG. 5 is a side view of the apparatus according to the present invention with respect to FIG. 1.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

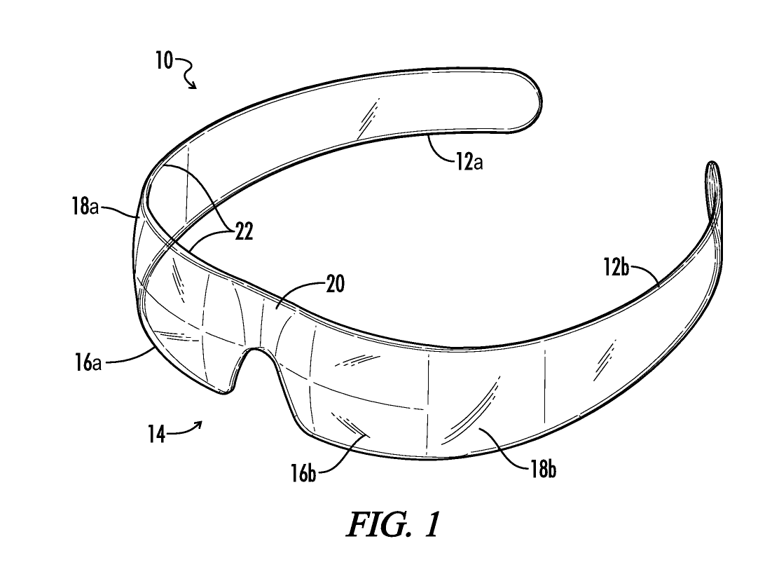

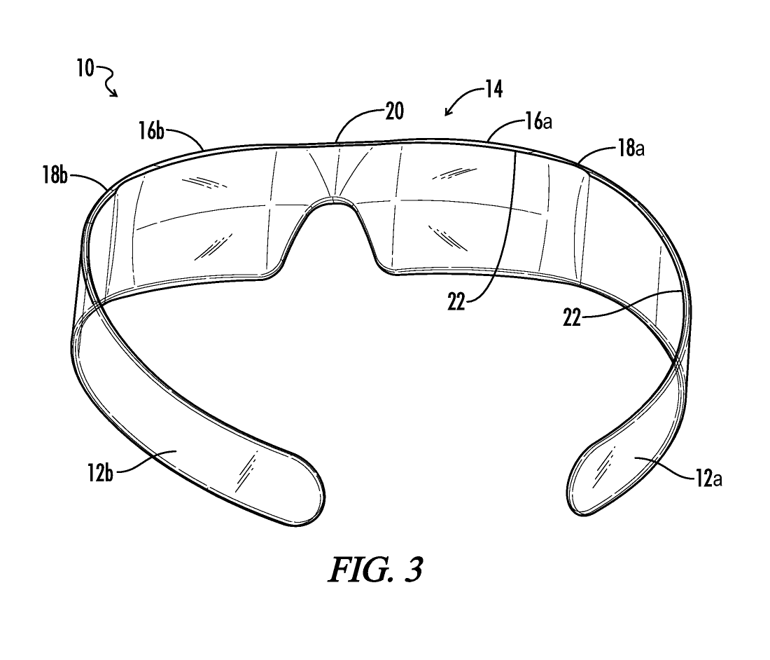

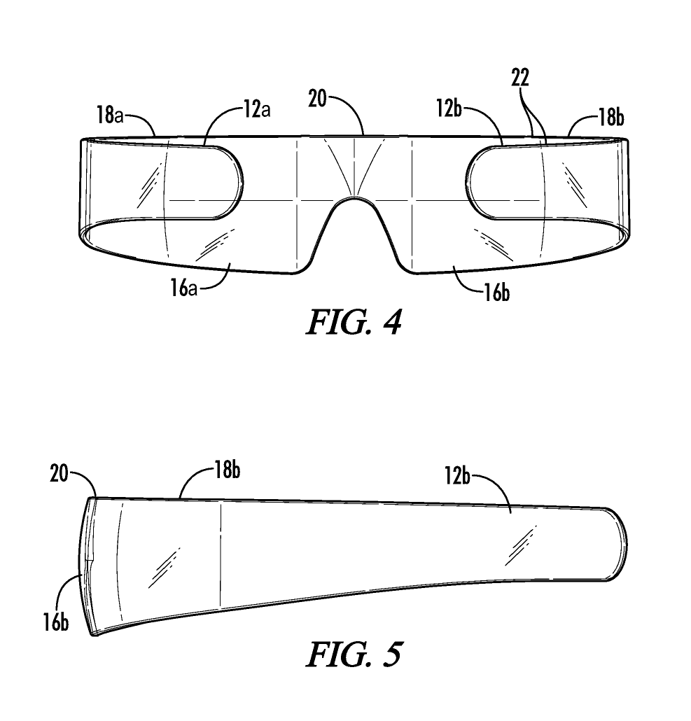

Referring generally to FIGS. 1-5, various embodiments may now be described of an integrally constructed apparatus that may be used as a headband or as prescription eyewear depending on the positioning with respect to a user's head. The apparatus is typically injection molded of a transparent, thermoplastic and substantially impact-resistant material such as for example polycarbonate resin, but it may be understood by those of skill in the art that alternative methods of construction and base materials may be considered within the scope of the present invention.

The apparatus may also typically be substantially clear in nature, but may within the scope of the present invention be tinted in color or shade while retaining transparent qualities in at least the viewing portions as may be understood and implemented by those of skill in the art.

In various embodiments, the apparatus may be constructed using a single mold and a plurality of inserts configured to provide desired and personalized parameters, including but not limited to corrective vision magnification levels. The inserts may in certain embodiments be constructed in a personalized fashion according to wrap optimization techniques and algorithms implemented in view of user specifications such as the physical shape and size of the head, and typically also the prescription.

Alternatively, in certain embodiments the apparatus may be constructed using one of a plurality of predetermined molds each adapted for a particular combination of shape, size, magnification level, etc.

Where the various figures may describe embodiments sharing various common elements and features with other embodiments, similar elements and features are given the same reference numerals and redundant description thereof may be omitted below.

As used herein, the term “base curve” may in the context of an apparatus according to the present invention generally relate to the curvature of an exterior surface for a given portion of the apparatus, as measured in Diopters and generally being inversely proportional to the radius of a cylindrical or spherical arc defined by that exterior surface, including but not limited to the optical portions.

Referring first to FIG. 1, an integrally constructed apparatus 10 in an embodiment of the present invention may include elongated arcuate and opposing temples 12 on either side of a front or central portion 14. The front 14 further includes first and second viewing portions 16a, 16b which may in various embodiments as further described herein be configured for magnification with respect to a user prescription or more generalized corrective viewing requirements. The front 14 may further include a bridge 20 between the viewing portions 16a, 16b, which may typically be non-magnifying and may further be configured with respect to the shape of a nose or otherwise ribbed, etc., to facilitate user comfort while using the apparatus 10 as eyewear.

The apparatus 10 may typically be constructed so as to define a substantially continuous arcuate interior, wherein a user may comfortably position the apparatus 10 around the head in either of an eyewear position so as to see through the pair of viewing portions 16, 16b, or in a headwear position as a hairband or the like. The arcuate interior of the apparatus 10 may typically be defined from an overhead view as represented in FIG. 1 and further with respect to an upper and/or lower edge of the interior surface 22, as portions of the apparatus such as for example the magnification areas may have a substantially spherical configuration whereas the temples have a substantially cylindrical configuration with respect to the center of a radius of curvature for the associated exterior surfaces.

As represented in FIG. 1, the apparatus 10 includes one or more transition portions 18, between the temples 12 and the viewing portions 16. These transitions 18 may typically be non-magnifying in nature, and may otherwise serve to blend the substantially cylindrical configurations of the temples with the substantially spherical configurations of the magnification portions, where applicable. Alternatively, or in addition, the transitions may allow for more flexibility in curvature wherein the transitions may have the same base curve as for example the temples, but a different center with respect to the associated radius of curvature. In other embodiments (not shown), the transitions may be omitted wherein each temple (i.e., a single curved portion) engages an extended viewing portion.

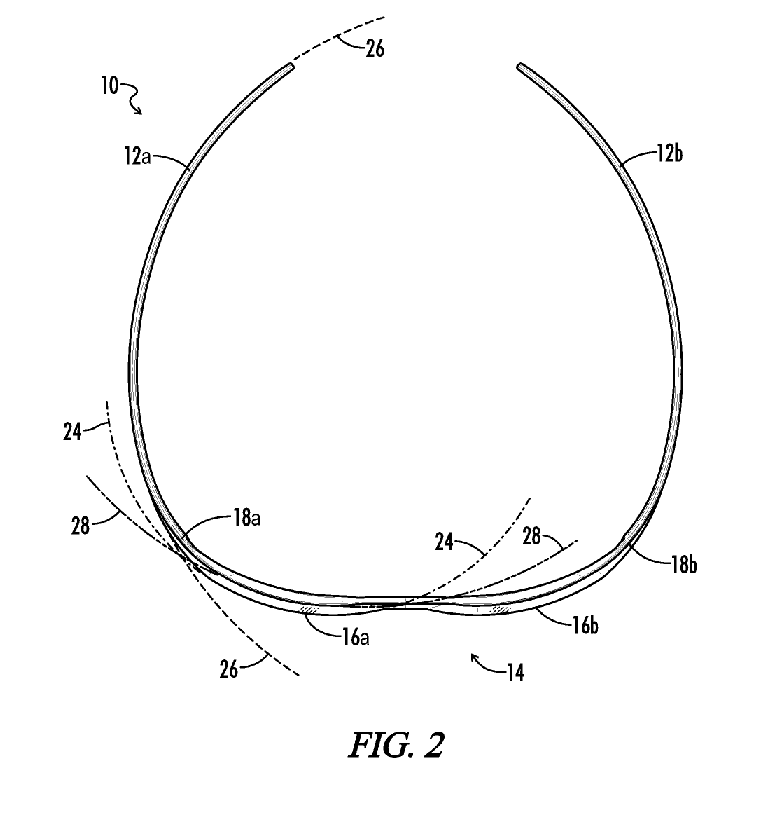

Referring further to FIG. 2, an exemplary configuration of the apparatus 10 may be characterized generally as having first and second sides, each side including a first base curve 26 associated with temple portion 12. Each side further includes a viewing portion 16 with a second base curve 24. In certain embodiments, a transition portion 18 on each side may be provided to marry the requisite structural configurations of the temple and viewing portions, for example by implementing a gradual tapering with respect to the respective inner and outer surfaces. As at least the interior configuration of the viewing portion may conceivably vary for each of a plurality of magnification levels, the transition portions 18 may by necessity vary as well in thickness and degree in order to properly link the inner surface of the viewing portion to that of the temple in a continuous arcuate manner.

Generally by reference to the temple and front portions of an apparatus as represented in FIG. 2, each front portion including one or more transitions and generally notwithstanding magnification portions of the viewing portions 16 themselves, may in certain embodiments be collectively defined by a plurality of sub-portions each having substantially the same base curve value but differing with respect to the center of the respective radius of curvature. In this manner, the substantially arcuate configuration of the apparatus does not take on a circular shape or even a U-shape, such as would be difficult to integrate with an appropriate magnification level via the viewing portions, but rather a graduated but substantially continuous arc having one or more pivot points along the length of each side, and generally having an inwardly disposed characteristic at the distal ends of each temple. In an exemplary embodiment, the apparatus 10 as represented in FIG. 2 may thereby be characterized as having a sequential plurality of base curves (e.g., 26, 28) along each side, each base curve (again not including that of the viewing portions 16) having a value of for example 6.00 Diopters.

In an alternative embodiment (not shown), the temple and a portion of the front on each side collectively may be characterized by a single base curve, such as for example 6.00 Diopters, wherein no transitions are required as further discussed above.

Magnification portions in the viewing area of apparatus according to the present invention are characterized by base curves 24 of greater than a first value associated with the remainder of the apparatus. For example, wherein the temples and transition portions of the apparatus may have base curves of 6.0 Diopters, the magnification portions may measure 6.5 Diopters or more depending on the particular requirements of the user. The variable thickness of each magnification portion along its length, as well as the interior surface configuration, associated curvature, and other shape-related parameters may typically be defined in accordance with the particular requirements of the user to achieve a desired magnification level. Exemplary magnification levels as may be achieved according to embodiments of the present invention range from zero up to at least +3.0. The combination of base curves along the length of the apparatus generally may be blended to achieve a substantially continuous arcuate configuration along an interior edge, and a somewhat less continuous but nonetheless smoothly graduating configuration along an exterior edge to accommodate any variance inherent to the magnification requirements.

The previous detailed description has been provided for the purposes of illustration and description. Thus, although there have been described particular embodiments of the present invention of a new and useful “Integrally Molded Apparatus For Headwear and Wrap Eyewear,” it is not intended that such references be construed as limitations upon the scope of this invention except as set forth in the following claims.

What is claimed is:

1. A combined headwear and eyewear apparatus comprising:
first and second temple portions; and
a front portion integrally coupled to said first temple portion on a first end and to said second temple portion on a second end and defining a substantially continuous arcuate interior perimeter, wherein said front portion and temple portions are integrally constructed of a transparent material,
said temple portions each comprising a base curve having a first value,
said front portion further comprising first and second integral magnification portions each comprising a base curve having a value higher than said first value.

2. The apparatus of claim 1, said magnification portions comprising a base curve and a variable lens thickness shaped according to a predetermined magnification level.

3. The apparatus of claim 2, the predetermined magnification level selected from a plurality of levels comprising 0.0, +1.0, +1.5, +2.0, +2.5 and +3.0.

4. The apparatus of claim 1, the base curve for each of the temple portions measuring at least 6.0 Diopters.

5. The apparatus of claim 4, the base curves for the magnification portions measuring between 6.5 and 7.0 Diopters.

6. The apparatus of claim 1, the integrally constructed transparent material comprising a polycarbonate resin.

7. The apparatus of claim 6, wherein said polycarbonate resin is tinted.

8. The apparatus of claim 1, the temple portions comprising a substantially cylindrical interior surface curvature.

9. The apparatus of claim 8, the front portion comprising one or more non-magnifying portions comprising a substantially cylindrical interior surface curvature and said magnifying portions comprising a substantially spherical interior surface curvature.

10. A combined headwear and eyewear apparatus comprising:
a transparent material shaped according to the head of a user and integrally comprising first and second opposing temples and a front defining a substantially continuous arcuate interior perimeter;
said first temple and front defining a first side comprising a sequential plurality of curved portions each having a first base curve value;
said second temple and front defining a second side comprising a sequential plurality of curved portions each having said first base curve value;
said front further comprising first and second magnification portions having a base curve value higher than said first base curve value.

11. The apparatus of claim 10, said magnification portions comprising a base curve and a variable lens thickness shaped according to a predetermined magnification level.

12. The apparatus of claim 11, the predetermined magnification level selected from a plurality of levels comprising 0.0, +1.0, +1.5, +2.0, +2.5 and +3.0.

13. The apparatus of claim 10, each of said sequential plurality of curved portions measuring at least 6.0 Diopters.

14. The apparatus of claim 13, the base curves for the magnification portions measuring between 6.5 and 7.0 Diopters.

15. The apparatus of claim 10, the transparent material comprising a polycarbonate resin.

16. The apparatus of claim 15, wherein said polycarbonate resin is tinted.

17. The apparatus of claim 10, the temples comprising a substantially cylindrical interior surface curvature.

18. The apparatus of claim 17, the front comprising one or more non-magnifying portions comprising a substantially cylindrical interior surface curvature and said magnifying portions comprising a substantially spherical interior surface curvature.

19. A combined headwear and eyewear apparatus comprising:
first and second temple portions; and
a front portion integrally coupled to said first temple portion on a first end and to said second temple portion on a second end and defining a substantially continuous arcuate interior perimeter, wherein said front portion and temple portions are integrally constructed of a transparent thermoplastic material,
said temple portions each comprising a base curve having a value of at least 6.0 Diopters,
said front portion further comprising first and second viewing portions each comprising a base curve having a value of at least 6.5 Diopters.

20. The apparatus of claim 19, the first and second viewing portions shaped according to a predetermined magnification level selected from a plurality of levels comprising 0.0, +1.0, +1.5, +2.0, +2.5 and +3.0.
